(19) United States
(12) Patent Application Publication
(10) Pub. No.: US 2007/0080252 A1
(43) Pub. Date: Apr. 12, 2007

(54) Shredder maintenance material delivery system

(75) Inventors: David Pierce, Renton, WA (US); Edward Urquhart, Bellevue, WA (US)

Correspondence Address: PERKINS COIE LLP;PATENT-SEA, P.O. BOX 1247, SEATTLE, WA, 98111-1247, US

(73) Assignee: Seanet Development, Inc., Bellevue, WA (US)

(21) Appl. No.: 11/516,684

(22) Filed: Sep. 5, 2006

Related U.S. Application Data
(63) Continuation-in-part of application No. PCT/US05/29558, filed on Aug. 19, 2005.
(60) Provisional application No. 60/713,965, filed on Sep. 2, 2005.
(60) Provisional application No. 60/715,317, filed on Sep. 8, 2005.

(51) Int. Cl. B02C 1/08; B02C 13/20; B02C 7/04

(52) U.S. Cl. 241/236

(57) ABSTRACT

In one embodiment, a shredder maintenance material delivery system includes a leader and a containment vessel. The containment can be configured to carry a maintenance material and configured to apply the maintenance material to at least on shredder component when the shredder maintenance material delivery system is shredded.

### CROSS-REFERENCE TO RELATED APPLICATIONS

This application is a continuation in part of PCT Application No. PCT/US2005/029558, entitled LUBRICATING SYSTEM FOR SHREDDERS, filed Aug. 19, 2005, which designated, inter alia, the U.S., which was published in English, and which is hereby incorporated herein by reference in its entirety. Additionally, this application claims priority to and the benefit of U.S. Provisional Patent Application No. 60/713,965 entitled SHREDDER MAINTENANCE MATERIAL DELIVERY SYSTEM, filed Sep. 2, 2005, and U.S. Provisional Patent Application No. 60/715,317 entitled SHREDDER MAINTENANCE MATERIAL DELIVERY SYSTEM, filed Sep. 8, 2005, each of which is hereby incorporated herein by reference in its entirety.

### TECHNICAL FIELD

The present invention is related to shredder maintenance material delivery systems, including cleaning and/or lubricating systems for shredders, such as paper shredders.

### BACKGROUND OF THE INVENTION

It is well known that mechanical apparatus employing moving parts that contact each other often require external lubrication and cleaning. For many such apparatus, specialized fittings or lubrication and cleaning conduit designs can be employed to facilitate periodic lubrication. However, certain apparatus or components thereof are difficult to lubricate or clean through specialized fittings or conduits, and require user intervention in combination with dexterity to accomplish critical lubrication or cleaning actions. For example, paper shredders frequently employ cutting elements that require periodic lubrication lest the apparatus fail through extended use without sufficient lubrication. Additionally, since these shedders are used to shred the gummed adhesive of labels and closures attached or part of paper envelopes, CDs or credit cards, etc. Cleaning of the resulting build up of adhesives and other residue is required in order to achieve the optimum lubrication. Current lubrication and cleaning regimens for conventional paper shredders require a user to carefully apply liquid lubricant or cleaner from an applicator to selected portions of the apparatus. This task is both tedious and inefficient.

There is, therefore, a need for a convenient and effective means for providing suitable cleaning and lubrication of apparatus such as a paper shredder that does not require significant user actions, and yet achieve desired levels of apparatus cleaning and lubrication.

Additionally, many such machines or shedders employ an electric eye sensor to start the blades in motion so that the items can be pulled through the shedder as the item is shredded. It is also optimum to the cleaning and lubrication process that these blades be in motion during cleaning and lubrication to more uniformly spread the lubricant or cleaning solution and achieve more complete coverage and best results.

### SUMMARY OF THE INVENTION

One embodiment of the present invention provides an apparatus for applying a cleaning solution and/or a lubricant to a mechanical apparatus, such as a paper shredder. A brief summary of some embodiments and aspects of the invention are presented. Thereafter, a detailed description of the illustrated embodiments is presented, which will permit one skilled in the relevant art to understand, make, and use aspects of the invention. One skilled in the relevant art can obtain a full appreciation of aspects of the invention from the subsequent detailed description, read together with the figures, and from the claims, which follow the detailed description.

### BRIEF DESCRIPTION OF THE DRAWINGS

FIG. 1 is an exploded perspective view of a lubricating assembly in accordance with an embodiment of the present invention.

FIG. 2 is an exploded perspective view of another embodiment showing a fluid impregnated carrier between two exterior lubricant impervious sheets.

FIG. 3 is a perspective view of an illustration representing another embodiment with lubricant filled micro-channels and no exterior sheets.

FIG. 4 is a partially exploded perspective view of another embodiment of the present invention.

FIG. 5 is a schematic view of another embodiment having air release portions or channels.

FIG. 6 is a schematic view of other embodiments with portions for triggering an electric eye mechanism of a shredder.

FIG. 7 is a schematic view of another embodiment having a cleanser portion and a lubricating portion.

FIG. 8 is a schematic view of another embodiment having a cleanser portion, a cleaning pause portion, and a lubricating portion.

FIG. 9 is a schematic view of another embodiment having a cleanser portion, an intermediate portion and a lubricating portion.

FIG. 10 is an isometric illustration of a shredder maintenance material delivery system in accordance with other embodiments of the invention.

FIGS. 11-16 are partially schematic illustrations of the shredder maintenance material delivery system shown in FIG. 10.

FIGS. 17-18 are isometric illustrations of a shredder maintenance material delivery system in accordance with still other embodiments of the invention.

FIGS. 19-20 are partially schematic illustrations of the shredder maintenance material delivery system shown in FIG. 17.

FIGS. 21-22 are isometric illustrations of portions of the shredder maintenance material delivery system shown in FIG. 17.

FIGS. 23-24 are isometric illustrations of portions of the shredder maintenance material delivery system shown in FIG. 17.

FIGS. 25-26 are isometric illustrations of a shredder maintenance material delivery system in accordance with still other embodiments of the invention.

FIG. 27 is an isometric illustration of a shredder maintenance material delivery system in accordance with yet other embodiments of the invention.

FIGS. 28-30 are isometric illustrations of portions of the shredder maintenance material delivery system shown in FIG. 27.

FIG. 31 is an isometric illustration of a shredder maintenance material delivery system in accordance with still other embodiments of the invention.

FIGS. 32-33 are isometric illustrations of portions of the shredder maintenance material delivery system shown in FIG. 31.

FIG. 34 is a partially schematic illustration of a shredder maintenance material delivery system in accordance with yet other embodiments of the invention.

FIG. 35 is a partially schematic cross-sectional side elevation of a shredder maintenance material delivery system in accordance with still other embodiments of the invention.

### DETAILED DESCRIPTION

Shredder maintenance material delivery systems and related methods are described in detail herein in accordance with various embodiments of the present invention. In the following description, numerous specific details are discussed to provide a thorough and enabling description for embodiments of the invention. One skilled in the relevant art, however, will recognize that the invention can be practiced without one or more of the specific details. In other instances, well-known structures or operations are not shown or are not described in detail to avoid obscuring aspects of the invention.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section. Furthermore, unless the context clearly requires otherwise, throughout the description and the claims, the words “comprise,” “comprising,” and the like are to be construed in an inclusive sense as opposed to an exclusive or exhaustive sense, i.e., in a sense of “including, but not limited to.” Additionally, the words “herein,” “above,” “below,” and words of similar import, when used in this application, shall refer to this application as a whole and not to any particular portions of this application. Use of the word “or” in reference to a list of items is intended to cover a) any of the items in the list, b) all of the items in the list, and c) any combination of the items in the list.

In one embodiment of the invention, a cleaning/lubricating system is provided that applies a lubricating material and/or a cleaning solution to a paper shredder. The cleaning/lubricating system can include a substantially flexible, generally planar envelope that contains a cleaning solution or lubricant. The planar envelope is passed through the shredder, and as the envelope is being shredded, the cleaning solution and/or lubricant is automatically delivered to the shredding mechanism in the shredder.

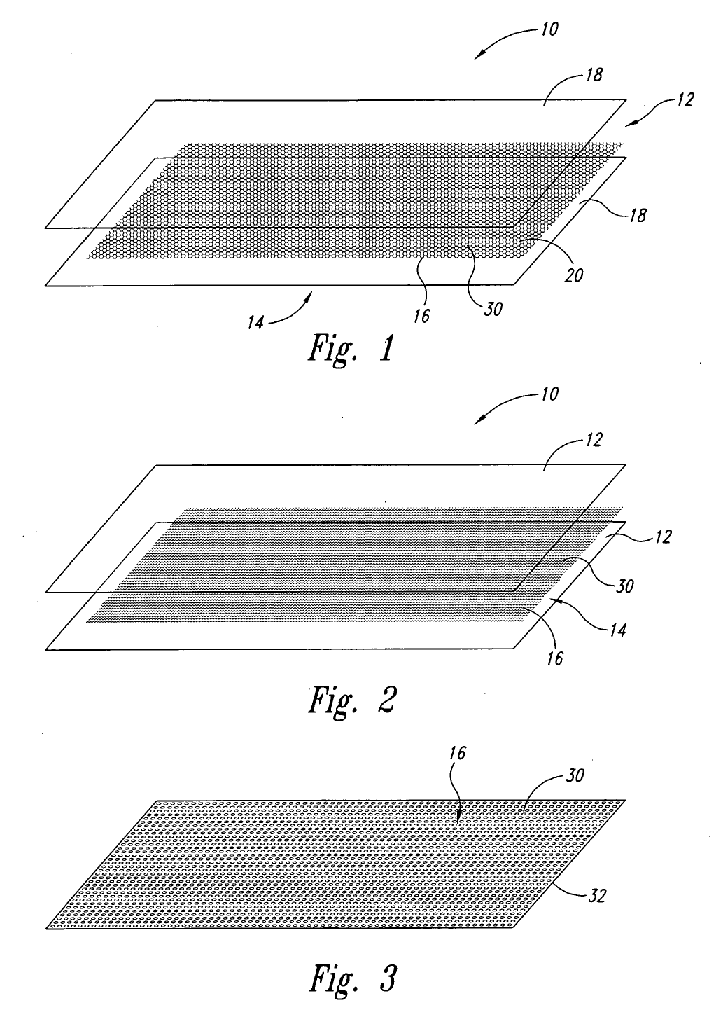

Under one aspect of the present invention, an embodiment includes a disposable, generally flexible and planar assembly 10 having at least one envelope 12, with an interior compartment 14, containing a cleaning solution and/or lubricant 16 (or other material to be delivered to the shredder or other mechanism). In one embodiment shown in FIG. 1, the envelope 12 has two exterior sheets 18 sealably joined together to form the interior compartment. In the illustrated embodiment, the cleaning solution and/or lubricant 16 is contained within a plurality of small pockets 20 that can be formed in a carrier sheet 30 contained in the compartment, or the pockets can be integrally formed in the two exterior sheets 18.

In another embodiment shown in FIG. 3, the envelope 12 includes a carrier sheet 30 with micro-channels 32 that contain the cleaning solution and/or lubricant 16. In another embodiment, the micro-channels 32 containing the cleaning solution and/or lubricant 16 are integrally formed in the exterior sheets 18.

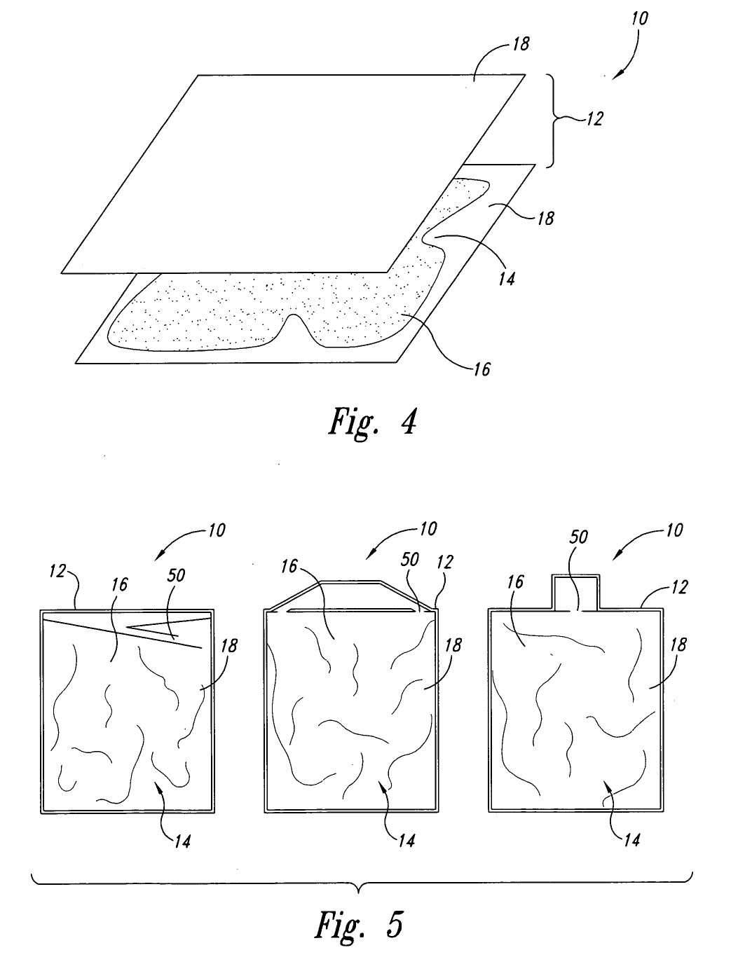

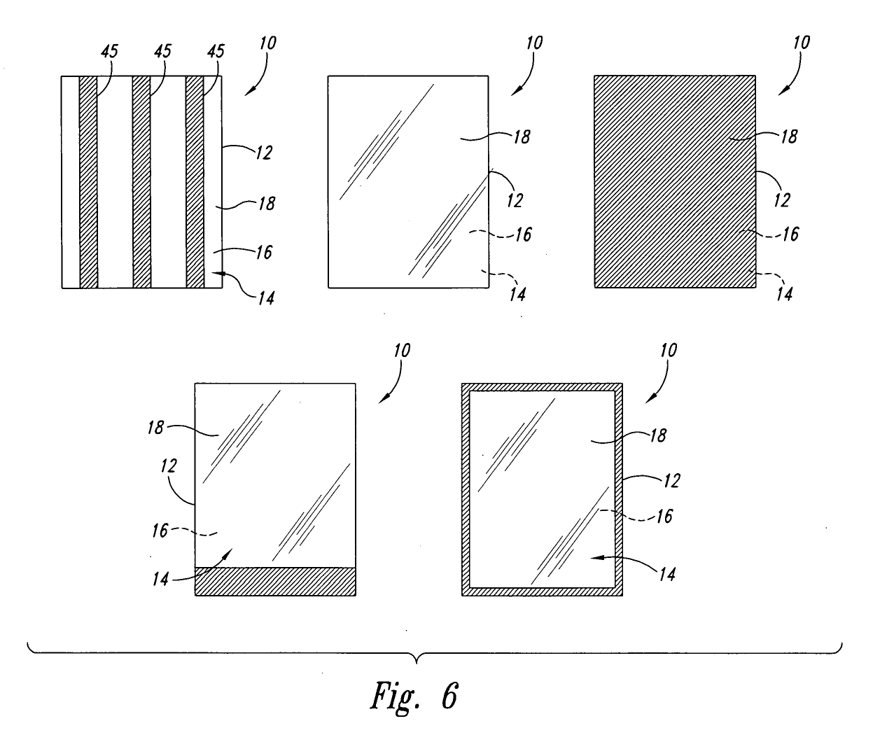

In another embodiment shown in FIG. 4, the assembly 10 is configured with two compartments 14 in the same envelope 12. One compartment 14 contains a cleaning solution and the other compartment contains a lubricant. As the envelope 12 is passed through the shredder, the assembly 10 will deliver the cleaning solution and the lubricant separately and sequentially. In other embodiments, more than two compartments 14 can be formed in the envelope 12, and lubricants, cleaning solutions, or other materials can be contained in the compartments and isolated from each other. The cleaning solutions, lubricants, and other materials can include various compositions and/or be present in various forms.

If the cleaning solution or lubricant is in liquid form, then the material forming the envelope 12 (e.g. the exterior sheets 18) is substantially fluid impervious. In one embodiment, the lubricant can be a biodegradable soy-based or other ‘vegetable based lubricant or can be a petroleum, graphite, Teflon or silicone based lubricant. The cleaning solution can be a citrus based, petroleum or other synthetic degreasing or de-gumming cleaner, wax remover and/or adhesive remover. In other embodiments, the lubricant can be dry carbon, graphite, Teflon, paraffin, carnauba wax or other slip coefficient increasing products or materials, in sheeted form, particulate, or pieces. The cleaning solution can be dry super fine abrasive or abrasive carried in a paste, liquid or semi liquid form, sheeted cleaning solvent or solvent and or cleaning material impregnated cloth, cellulose or other carrier. Same can be degreaser, or bleach or ammonia based product with or without scent added. In some embodiments, the lubricant is isolated (e.g. not mixed) with the cleaning solution when contained in the envelope 12. In other embodiments, the lubricant is combined with (e.g. mixed) with the cleaning solution. In other embodiments, the envelope 12 can contain only the lubricant or only the cleaning solution. In other embodiments, the envelope 12 contains a solution that is both a cleaner and lubricant (e.g., a single solution that is a de-greaser, cleaner, and lubricant).

In other embodiments, the cleaning solution and/or lubricant 16 can include a fragrance that will be released when the envelope 12 containing the cleaning solution and/or lubricant is being shredded. The fragrance can be, as an example, oil-based compositions that provide the lubricating oil with a pleasant fragrance, such as sandalwood, lavender, lemongrass, peppermint, orange, peach, apricot, eucalyptus, spearmint, or other material that provides a desirable scent.

When the envelope 12 is placed into a paper shredder, the shredding mechanism will not start to shred unless an electric eye (or other mechanism) is activated, such as by interrupting an optical beam or the like. In the embodiment having a liquid in the envelope 12 with or without a carrier sheet, the envelope has several ways of triggering the electric eye on a shredder. The envelope 12 can be substantially opaque, partially opaque, and/or reflective in order to activate the electric eye on most machines. This can be achieved through coating or coloring the envelope 12 material, metalizing, strategic printing one or both surfaces and/or pattern(s) on the surface(s) to match the locations needed to interrupt an optical signal or activate the electric eye. For example, the exterior sheets can have an opaque strip 45 printed thereon and positioned to activate the electric eye.

If the cleaning solution or lubricant 16 is in solid form (such as a dry cleaner or lubricant or one that is carried in an encapsulated form), then the envelope 12 need only be capable of retaining such solid cleaning solution and/or lubricant prior to dispersal in the apparatus. In the embodiments with the lubricant or cleaning solution 16 and without a carrier sheet 30 in the compartment, the system will have a more effective delivery system for commonly owned shredders, as there can be more cleaner or lubricant available to accomplish the task.

Another embodiment comprises a disposable, generally flexible and planar carrier sheet 30 impregnated with or carrying a liquid or solid cleaner or lubricant. The planar carrier sheet 30 can be fully contained in the envelope 12. For example, the carrier sheet, such as a paper material similar to a paper towel, can be impregnated with a liquid oil that would be very messy to handle by itself. Accordingly, this liquid impregnated carrier sheet 30 could be sealed in an envelope 12. Alternatively, the carrier sheet 30 could be impregnated with a dry material. Accordingly, this dry carrier sheet could be used without the envelope 12. The dry carrier could, however, be enclosed in the envelope 12 for other reasons.

When the envelope 12 or the carrier sheet 30 are fed into an activated shredder, the shredding mechanism cuts or otherwise breaks apart the envelope 12 (or carrier) and releases the cleaning solution and/or lubricant. The cleaning solution and/or lubricant is transferred to the mechanical components of the apparatus, thus achieving the objective of component cleaning and/or lubrication. With respect to embodiments using an envelope 12, the shredder must be capable of breaching the envelope 12 to expose the cleaner or lubricant.

In the illustrated embodiments, at least one cleaner or lubricant-filled envelope 12 is created to carry a defined quantity of cleaner or lubricant to the target apparatus components. If the cleaner or lubricant is in a fluid phase, the envelope 12 may be constructed from any suitable paper or film such as liquid lubricant impervious foil, plastic, rubber, cellulose, PLA, synthetic dextrose, fabric (synthetic or natural), Mylar® or laminates of the above (i.e. our PLA coated paper sheets made into pouches to deliver cleaner or lubricant) to achieve a fluid impervious envelope 12.

It is desirable for the effective distribution on and coverage of the gears and shredding mechanisms to have the material forming the envelope 12 be of a somewhat brittle nature, and thereby shred or “break”, rather that simply tear or puncture in the process. This characteristic (which is demonstrated by the embodiment using PLA as the envelope material) dramatically increases the dispersal of the cleaner or lubricant to the shredding mechanisms. The use of a brittle material causes more liquid to be freed from envelope 12 because the carrier is disintegrating more fully and not merely being punctured. The selection of suitable envelope 12 material depends in part upon the apparatus and the final disposition of the envelope 12 (e.g., for paper shredder applications, paper-recycling guidelines may prevent the inclusion of the envelope 12 as a byproduct unless the same and the lubricant are biodegradable). In one embodiment the PLA materials and PLA coated paper are recyclable, biodegradable and compostable. These same materials or others may be used to create a suitable envelope 12 for carrying a solid phase lubricant. Moreover, the envelope 12 may carry special indicia printed on the exposed surface(s) thereof to differentiate the envelope 12 from other items that may be subject to processing by the apparatus. The envelope 12 may also carry special branding or advertising indicia, or other select markings.

A suitable envelope 12 may be constructed from sheets of the aforementioned materials that are combined through heat sealing, adhesives, mechanical fasteners or interlocks (such as slide fasteners, e.g., Ziploc®). While at least one envelope 12 containing a cleaning solution or lubricant can be used for operation of some embodiments regardless of the cleaner or lubricant phase, a plurality of envelopes 12 may be created within a single application material to assist in lubricant dispersal or manufacturing steps. The plurality of envelopes 12 may be established concurrently with or after creation of a single envelope 12, or may be independently created to form a plurality of lubricant filled compartments. Moreover, the plurality of envelopes or compartments, which may be within the primary envelope boundaries, may or may not be in fluid communication with each other, depending upon dispersal and manufacturing objectives. The plurality of envelopes 12 or compartments 14 may have a regular orientation or may be generally randomly oriented. Moreover, the envelopes 12 or compartments 14 may be of any geometric shape; the envelopes or compartments may be homogeneous or heterogeneous with respect to each other.

In another embodiment, the carrier sheet 30 impregnated with or containing a cleaner or lubricant. The cleaner or lubricant may be in liquid or solid phase, which will also affect the selection of a suitable carrier for the cleaner or lubricant. Particularly if the cleaner or lubricant is in liquid form, it is desirable to surround the carrier with cleaner or lubricant impervious material. In one embodiment, the carrier sheet impregnated or containing the cleaning solution and/or lubricant is contained in a sealed envelope 12. The envelope 12 with the carrier sheet 30 can be placed into the shredder. Accordingly, envelope 12 may be used to isolate the carrier sheet 30 from exposure to the environment prior to engagement with the shredder and its components.

In the embodiment with the carrier sheet in the envelope's compartment, the carrier is necessarily smaller than the inside dimensions of the envelope 12. The resultant difference when added to the dimension from the extreme outside of the envelope 12 to the seal, plus the thickness of the seal, can easily add up to a width that keeps the interior carrier from contact with the electric eye. Dispensing with the carrier in embodiments provides more consistent results, and it has less material costs to produce.

In use, an envelope 12 in accordance with the embodiments discussed above is introduced into the shredder. As the shredding mechanisms are activated, the mechanisms breach the envelope(s), thus exposing the components to the lubricant, or directly interacts with the carrier sheet 30 after its exposure to the carrier sheet. The envelope 12 (and carrier sheet if in the envelope) is fully shredded and the cleaning solution and/or lubricant is automatically delivered to the shredding mechanism, and then automatically shredded and disposed of with the other shredded material.

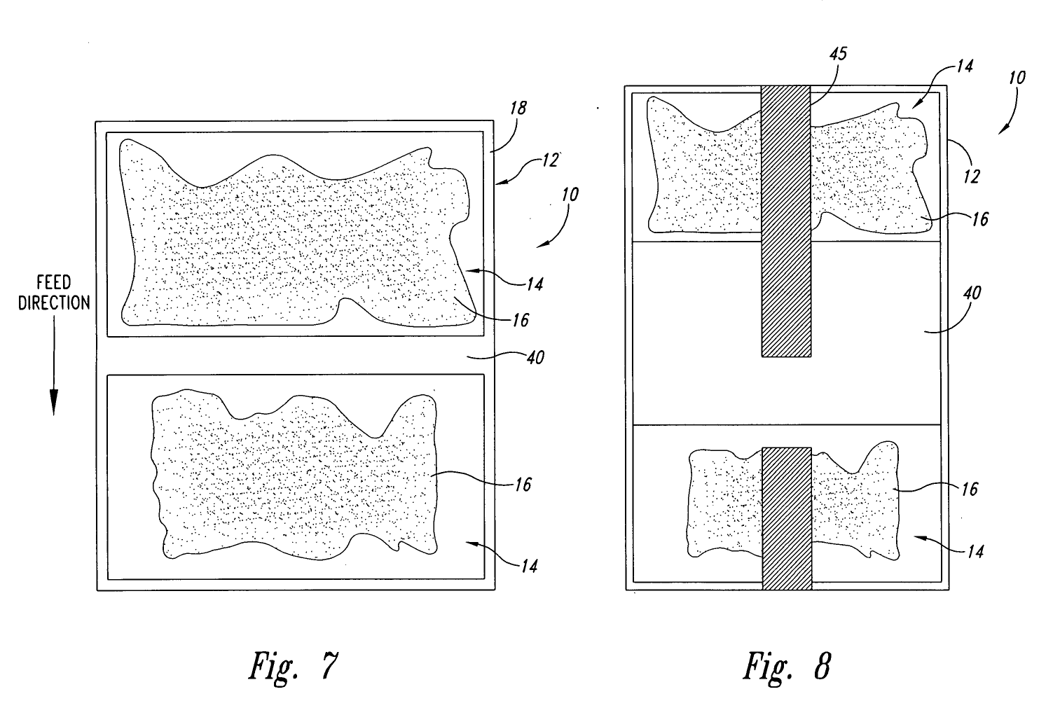

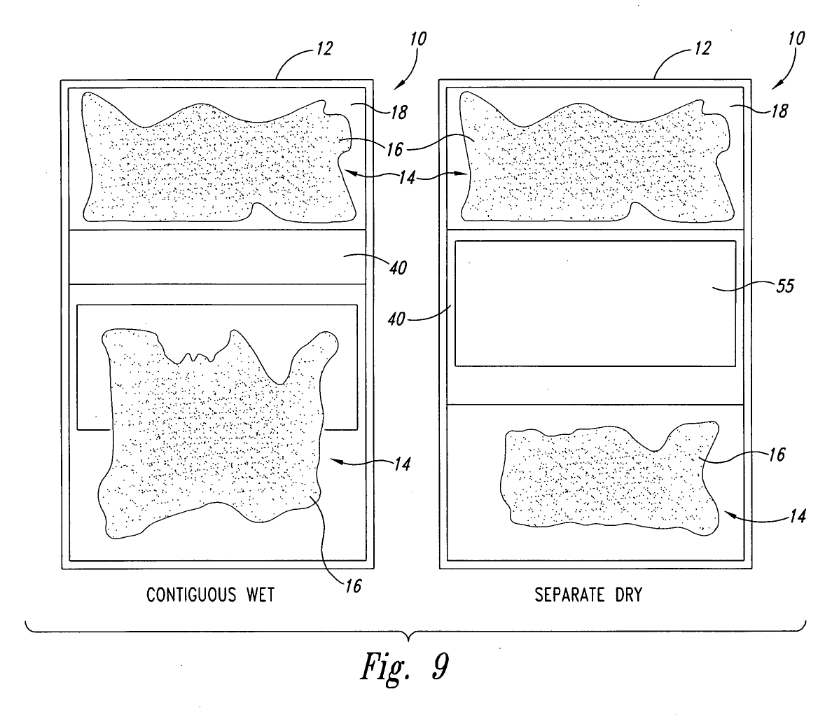

In other embodiments (FIG. 7), an envelope 12 is provided with two or more separate compartments 14 for the lubricant and the cleaning solution. The compartments 14 are sealed and arranged so that, as the envelope 12 is shredded, the envelope will first deliver cleaner to the shredder and then will deliver the required lubrication to the shredder. In another embodiment shown in FIG. 8 and FIG. 9 the envelope 12 has two or more separate compartments spaced apart from each other by a gap 40. In the illustrated embodiment, a cleaning solution is contained in the first compartment, and the lubricant is contained in the second compartment. When the envelope 12 is fed into the shredder, the cleaning solution will be dispensed first, and then the portion forming the gap 40 will move through the shredder before the shredder reaches the compartment 14 with the lubricant. Accordingly, the gap 40 will cause a pause before dispensing the lubricant, thereby giving the cleaning solution extra time to work. The amount of the delay is defined by the size of the gap 40 (and the speed of the shredder). Different embodiments can have different sized compartments and/or gaps 40.

In another embodiment, a time delay or “gap” 40 can be created by providing a break in a portion of the envelope 12 that activates the electric eye of the shredder. As an example, the envelope 12 can have an opaque strip 45 positioned to activate the electric eye, and the opaque strip 45 can have a break so that the shredder will temporarily turn off when the break in the strip gets to the electric eye. As the shredder shuts off, a pause occurs before the shredder reaches the next compartment in the envelope 12. In one embodiment, the break may be sized so that the shredder will remain off until a user re-feeds the rest of the envelope 12 through the shredder. Other breaks can be used from other timing purposes to control the shredder. In another embodiment shown in FIG. 9, the space in the envelope 12 between the compartments with the fluids is occupied by a sheet of material 55 (paper, cellulose, spun plastic, cloth or PLA ingeo® fabric, which can either be in a separate (dry if required) compartment of the envelope 12. This sheet of material can provide a wiping of loosed adhesive particulate as well as a drying function before the following application of lubricant. Such wiping may be desirable to allow the lubricant to attain more uniform coverage with a reduced presence of the solvent or surfactant residue of the cleaning fluid. In another embodiment, the sheet of material may be contained in the same compartment as the cleaning fluid to achieve a “wet scrub” action through the first cleaning fluid cycle. The same space or gap discussed above could be provided in a desired position (and size) to allow for a pause in shredding for air drying before lubrication.

The compartment(s) in the envelope 12 are sealed so the material (e.g. fluid or solid) is fully contained until the compartment 14 is breached. In one embodiment shown in FIG. 5, the envelope 12 includes an optional air channel 50 for use when the appropriate amount of air cannot be removed from the compartments during manufacture. This air channel 50 provides an area for excess air in the cavity to go as the envelope 12 is being squeezed as it is fed into the shredder. Accordingly, the air channel 50 helps avoid a “pop” or explosion at an upper part of the envelope 12, which could result in an unwanted splatter of liquid lubricant or cleaning solution which occurs when an air bubble containing liquid is (“squeegeed”) compressed and then pops under pressure as the last inches (or fractions thereof) of the envelope 12 are fed through the narrow shredder opening and even narrower gaps between the shredder gears.

Other embodiments of the invention are directed generally toward a shredder maintenance material delivery system for applying maintenance material (e.g., cleaning and/or lubricant materials) to a mechanical apparatus, such as a paper shredder, by passing a containment vessel and/or a leader through a portion of the shredder. In selected embodiments, the containment vessel and/or the leader can be substantially flexible. For example, the containment vessel and/or the leader can be made of any number of flexible materials. In certain embodiments the leader can be connected, attached, or coupled to the vessel. In other embodiments, the vessel and leader can be substantially a single unit. In various embodiments, the containment vessel and/or the leader can contain or is made of maintenance material. For example, in selected embodiments, the containment vessel can be configured to contain or carry maintenance material, such as a cleaning solution or powdered lubricant configured to be applied to the shredder. In other embodiments, the leader and/or vessel can be made of the maintenance material and does not carry other materials.

In selected embodiments, the leader is inserted into the shredder so as to activate the blades, for example, via an electronic eye. The blades engage the leader and pull the leader into the shedder. In doing so, a downward pulling force is created on the leader and the vessel is pulled toward the blades. This pulling force and/or the blades can cause the vessel to rupture, thereby delivering maintenance material to the shredder blades from above. For example, “bathing” the blades and/or other shredder components in the maintenance material.

In certain embodiments, the shredder maintenance material delivery system can comprises a disposable, generally flexible material defining a containment vessel having at least one interior area containing maintenance material, for example, in liquid or solid form (e.g., a powder, an encapsulant, a paste, and/or a hydrogenised material). In other embodiments, the containment vessels can include multiple compartments configured to deliver various different types of maintenance materials, separately or together. For example, in selected embodiments one or more compartments can carry or be comprised of a cleaning material and other compartment(s) can carry or be comprised of a lubricant. In one embodiment, the compartments can be arranged so that as the delivery system is pulled into the shredder the cleaning material is delivered prior to the lubricant. In another embodiment, the compartments can be arranged so that the cleaning material and lubricant are delivered simultaneously or in an overlapping manner.

In embodiments where the maintenance material is carried by the containment vessel in liquid form, the containment vessel can be substantially fluid impervious or impervious to the type of maintenance material being carried. Additionally, in selected embodiments the containment vessel can be opaque, semi-opaque, and/or reflective in order to activate the electric eye that is used on many shredder machines. This can be achieved through coating or coloring at least portions of the material that makes up the vessel and leader. For example, in certain embodiments one or more portions of the vessel and/or leader can be metalized or include a printed pattern to match the locations needed to activate an electric eye. In other embodiments where the cleaning solution or lubricant is opaque or semi-opaque, then portions of the vessel and/or leader may only need to be capable of retaining such lubricant prior to dispersal in the apparatus.

In selected embodiments, at least one cleaner or lubricant filled containment vessel is created to carry a defined quantity of maintenance material to targeted shredder apparatus components. In certain embodiments, if the cleaner or lubricant is in a fluid phase, form, or state, the containment vessel may be constructed from any suitable paper or film such as liquid lubricant impervious foil, plastic, rubber, cellulose, PLA, synthetic dextrose, fabric (e.g., synthetic or natural), Mylar® or laminates of the above (e.g., PLA coated paper sheets made into pouches, envelopes, tubes or oblique containments to deliver maintenance, cleaner or lubricant) to achieve a fluid impervious containment vessel. In certain embodiments, it can be desirable to have the containment vessel material be of a somewhat brittle nature and thereby shred or “break” or easily. In other embodiments, the containment vessel can include tear through perforations, strategically placed scores, dividers, breaking points or lines, and/or other arrangements that tear or puncture in the process of shredding. In some cases, this characteristic can dramatically increase the dispersal of the maintenance, cleaner or lubricant material to the targeted shredder components.

In certain embodiments, the selection of suitable containment vessel material depends in part upon the targeted shredder components and the final disposition of the containment vessel. For example, with paper shredders, paper-recycling guidelines may prevent the inclusion of the containment vessel as a byproduct unless the containment vessel and the maintenance materials are biodegradable. Accordingly, in selected embodiments the containment vessel and maintenance materials are made from biodegradable materials or materials that meet other environmental requirements. For example, in selected embodiments the vessel can be made from a water soluble material that is configured to hold an environmentally friendly compound (e.g., certain types of oils) without breaking down. In further embodiments, the containment vessel may carry special indicia printed on the exposed surface(s) thereof to differentiate the containment vessel from other items that may be subject to processing by the shredder. For example, in a selected embodiment, the leader is biodegradable and configured to rupture the vessel as the leader is shredded. After the vessel is ruptured, maintenance material is dispensed above the blades of the shredder, providing the desired maintenance effect (e.g., cleaning and/or lubricating). During this process, the leader detaches and the vessel does not go through the shredder. Instead, the vessel can be lifted away from the shredder and disposed of separately.

In selected embodiments, a suitable containment vessel may be constructed by joining sheets of material via heat sealing, adhesives, mechanical fasteners, interlocks (such as slide fasteners, e.g., Ziploc®), or the like. In selected embodiments, the delivery system can include a plurality of containment vessels. For example, in certain embodiments the plurality of containment vessels may be established concurrently with or after creation of a single containment vessel, or may be independently created to form a plurality of lubricant filled compartments. Additionally, in selected embodiments, the plurality of containment vessels or compartments, which may be within the primary containment vessel boundaries if one exists, may or may not be in fluid communication with each other, depending upon dispersal and manufacturing objectives. In other embodiments, the plurality of containment vessels can be in fluid communication with one another. In still other embodiments, the plurality of containment vessels may have a regular orientation or may be generally randomly oriented. Moreover, in yet other embodiments the containment vessels may be of any geometric shape and/or the containment vessels may be homogeneous or heterogeneous with respect to each other.

In certain embodiments, the leader and/or vessel can be made of a material that contains or is impregnated with the maintenance material. In some embodiments where the leader and/or vessel is impregnated by a liquid maintenance material, it can be desirable to cover at least a portion of the leader and/or vessel with material that is impervious to the maintenance material prior to use (e.g., during transit and/or storage). In certain embodiments, this covering can be removed prior to use of the delivery system. In other embodiments, the delivery system can be fed to a shredder with the covering in place.

In various embodiments, the delivery system is introduced into a shredder apparatus whereupon mechanical interaction of the apparatus components breaches the containment vessel(s), thus exposing the components to the maintenance material, as an after delivery process incidental to the original delivery of material to the shredder blades. In other embodiments the maintenance material is delivered to the components as the leader and/or vessel contact the components (e.g., when the leader and/or vessel are, at least in part, made from the maintenance material). As discussed above, in selected embodiments the delivery system can first deliver one type of maintenance material and then deliver a second maintenance material. For example, in one embodiment the leader can be made from a cleaning material and the vessel can carry a lubricant that is dispersed when the vessel is breached. In other embodiments, multiple vessels and/or a vessel with multiple compartments or envelopes can be used to deliver different types of maintenance materials.

In still other embodiments, the dispensing of maintenance material can be timed, sequenced, and/or coordinated using various methods. For example, in certain embodiments the timely application of a cleaning fluid, followed by a lubricant can be accomplished via a gap between compartments in the containment vessel between compartments carrying the cleaning fluid and the lubricant or a portion of leader positioned between separate containment vessels. In other embodiments, a printed, embedded or affixed electric sensor strip or other device or method (e.g., RFID chip, magnetic stripe, barcode, etc.) can be used to coordinate the operation of the shredder and the release of various maintenance materials from the delivery system.

In selected embodiments, different types of maintenance materials can be spaced apart from one another in the containment vessel by one or more sheets or pieces of material (e.g., paper, cellulose, spun plastic, cloth or PLA ingeo® fabric). For example, in certain embodiments where a first maintenance material includes a cleaner and a second maintenance material includes a lubricant, a cloth can be used to space the solutions from one another. The cloth can also serve to provide a wiping of loosened adhesive particulate from the shredder as well as a drying function after the application of the cleaner and before the application of the lubricant. In certain instances, this arrangement can be desirable because the lubricant will attain more uniform coverage with a reduced presence of the solvent or surfactant residue of the cleaner. In other embodiments, the cloth (or other material) can be carried in the same compartment as the cleaner to achieve a “wet scrub” action through the first cleaning cycle. In this embodiment, a space or gap can then be used between the compartments carrying the cleaner and the lubricant to allow the shredder components to at least partially air dry before application of the lubricant. In still other embodiments, the cloth or other material can be carried in a dedicated compartment.

In another embodiment, the space between the fluids in the containment vessel is occupied by a sheet of material (e.g., paper, cellulose, spun plastic, cloth or PLA Ingeo fabric), which can either be in a separate (dry if required) compartment of the pouch/vessel (to provide a wiping of loosened adhesive particulate as well as a drying function before the following application of lubricant. This can be desirable as the lubricant can obtain a more uniform coverage with a reduced presence of the solvent or surfactant residue of the cleaning fluid) or in the same compartment as the cleaning fluid to achieve a “wet scrub” action through the first cleaning fluid cycle. The same space or gap can then be inserted as desired to allow for a pause in shredding for air drying before lubrication.

In another embodiment, the leader can be a “cleaner” or scrubber material prior to the containment vessel. The leader can be made of an abrasive or other material that wipes or scrubs the blades prior to the delivery of a maintenance material (e.g., a cleaning or lubricating fluid, paste, or solid).

In selected embodiments, the delivery system can be placed in an envelope. In certain embodiments, the envelope can be opaque or semi-opaque facilitating the operation of an electric eye, used in many shredders, to initiate shredder operation. Additionally, in certain embodiments the pouch may have bands of cohesive material that meet when folded together and provide a seal creating a pouch (e.g., enclosing the delivery system in the envelope). In selected embodiments, the envelope can be open at the top allowing the lubricant to “squeegee” up and out of the envelope and further enhance the “bath” of the blades as the delivery system passes into the shredder. In still other embodiments, the delivery can be low profile if no pouch is used to avoid contact with the electric eye and paper can be fed after the application to clean the deliver slot and/or to activate the electric eye.

In still other embodiments, the maintenance material can be a paste or cream dispensed from either a squeeze or compression tube (toothpaste types) or a pressurized can. The lubricating material can be hydrogenised or treated in a manner to have a paste or cream-like consistency. In selected embodiments, this can allow the material to stay on the blades longer, as it is less likely to run off the blades via gravity since it is less viscous than liquid oil, etc. resulting in better lubrication.

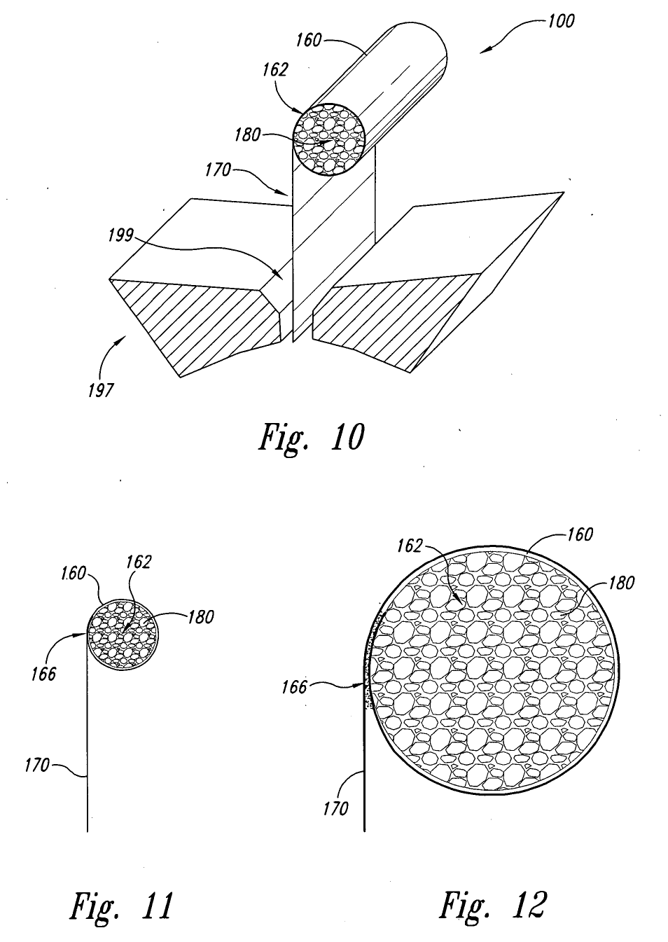

FIG. 10 is an isometric illustration of a shredder maintenance material delivery system 100 in accordance with other embodiments of the invention. In FIG. 10, the delivery system 100 includes a containment vessel 160 with an interior area 162. The vessel 160 carries a maintenance material 180 in the interior area 162. In FIGS. 10-16, the end of the containment vessel 160 has been removed so that the maintenance material 180 can be seen while it is in the containment vessel 160. The vessel 160 is attached to a leader 170 that is configured to be fed into a shredder feeder trough 199 of a shredder 197.

FIG. 11 is a partially schematic illustration of a portion of the shredder maintenance material delivery system 100 shown in FIG. 10. FIG. 12 is an enlarged partially schematic illustration of the portion of the shredder maintenance material delivery system 100 shown in FIG. 11. As shown in FIGS. 11 and 12, in the illustrated embodiment the containment vessel 160 and the leader 170 are made from a single sheet of material. The material is doubled over to create an interior portion 162 where the maintenance material 180 is carried. A seal 166 closes the interior portion 162, but is configured to rupture when the leader 170 is pulled into the shredder.

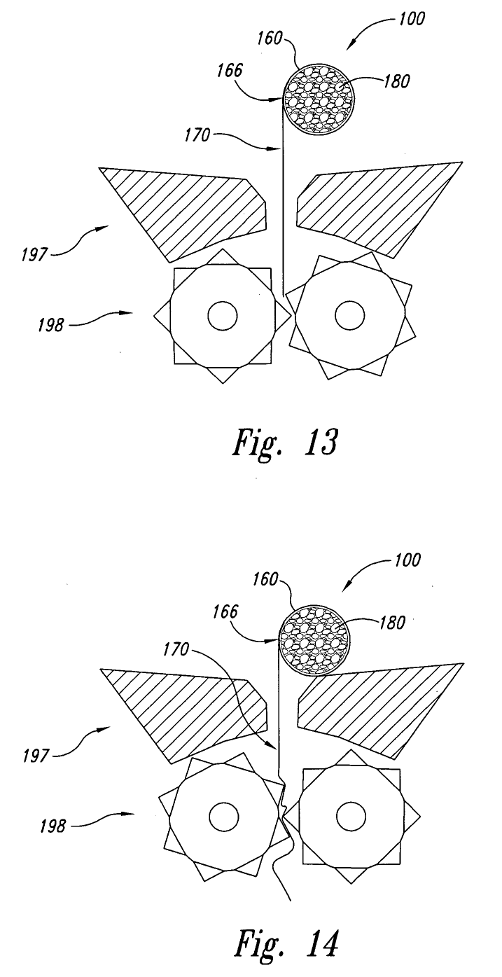

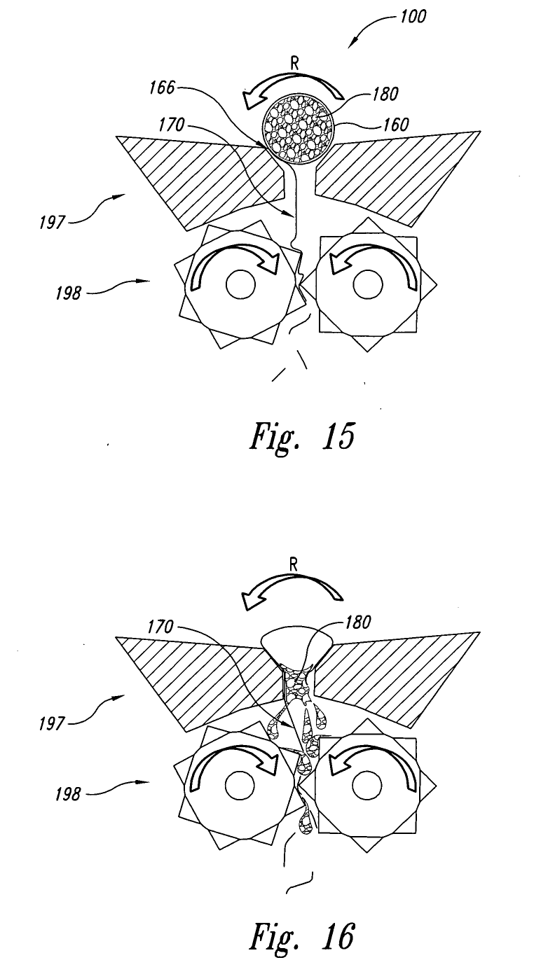

In FIG. 13, the delivery system 100 is being fed into the shredder 197. As the leader 170 engages shredder blades 198 the delivery system is pulled into the shredder. In FIG. 14, the leader 170 is being shredded and the containment vessel 160 has come in contact with a portion of the shredder 197. As shown in FIG. 15, as the leader 170 continues to be pulled through the shredder, the containment vessel rotates (as shown by arrow R) because the vessel is too large to pass through the shredder feeder trough 199 in its present (e.g., un-ruptured) configuration. Eventually, the downward force on the seal 166, produced by the leader being pulled through the shredder, causes the seal 166 to break or rupture. As shown in FIG. 16, when the seal/containment vessel ruptures, unrolls, or delaminates, the maintenance material 180 is released over the blades and/or other shredder components. In the illustrated embodiment, the ruptured containment vessel is pulled through the blades and shredded.

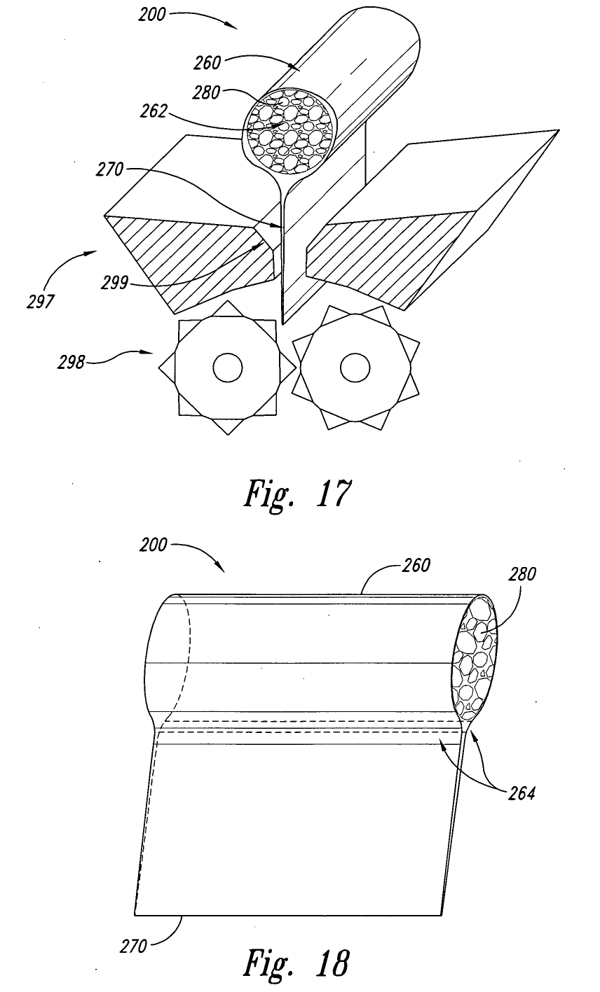

FIGS. 17-18 are isometric illustrations of a shredder maintenance material delivery system 200 in accordance with still other embodiments of the invention. In the illustrated embodiment, the delivery system 200 includes a containment vessel 260 with an interior area 262. The vessel 260 carries a maintenance material 280 in the interior area 262. In FIGS. 17-20, the end of the containment vessel 260 has been removed so that the maintenance material 280 can be seen while it is in the containment vessel 260.

The vessel 260 is attached to a leader 270 that is configured to be fed into a shredder feeder trough 299 and blades 298 of a shredder 297. As shown in FIG. 18, a portion of the delivery system 200 include scored or perforated regions 264 proximate to the containment vessel 260 configured to rupture or open the containment vessel 260 when a selected amount of force is applied to the regions 264. In the illustrated embodiment the delivery system 200 includes two regions 264, one on the front of the system 200 and one on the rear of the system 200. In other embodiments, the system 200 can have more, fewer, or different regions 264.

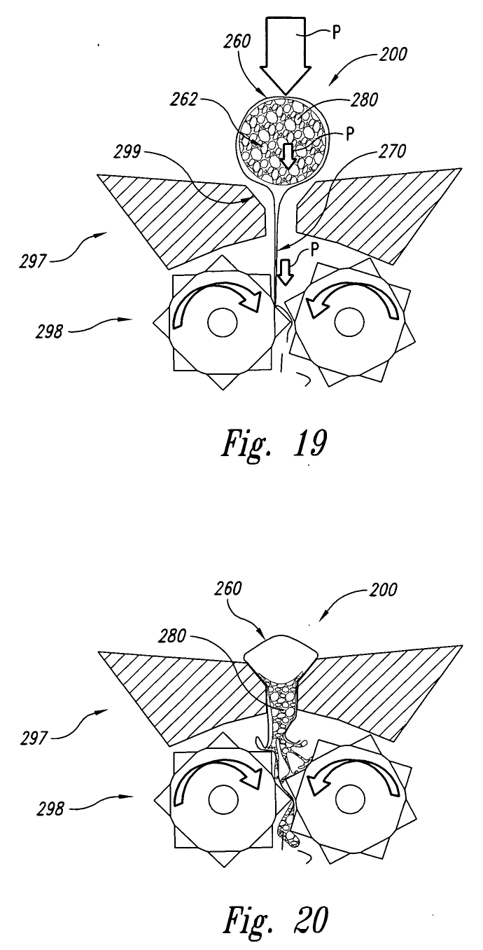

In FIG. 19, the delivery system 200 is being fed into the shredder 297. The leader 270 has engaged the blades 298 and the delivery system is being pulled into the shredder as the leader is being shredded. As the leader 270 is pulled into the shredder a downward force or pressure (shown as arrow P) is exerted on the delivery system 200. In FIG. 20, the containment vessel 260 has come in contact with a portion of the shredder 197. Because the vessel is too large to pass through the shredder feeder trough 299 in an un-ruptured configuration, once the once the vessel contacts the shredder, the downward force applied by the leader causes at least one of the regions 264 to break or rupture. When the region ruptures, containment vessel is ruptured or is opened, allowing maintenance material 280 to be released over the blades and/or other shredder components. In the illustrated embodiment, the ruptured containment vessel is pulled through the blades and shredded.

In other embodiments, the delivery system 200 can have other configurations. For example, in selected embodiments the delivery system does not include a scored or perforated region 264. Instead, a portion of the containment vessel is configured to extend downwardly into the shredder so that the portion of the containment vessel is ruptured by a portion of the shredder (e.g., the blades), thereby releasing the maintenance material. In still other embodiments, the delivery system can include multiple containment vessels carrying one or more types of maintenance material. In yet other embodiments, the containment vessel does not include a maintenance material. Instead, the leader and/or the containment vessel is made from one or more maintenance materials. In still other embodiments, the system only includes a leader or a containment vessel.

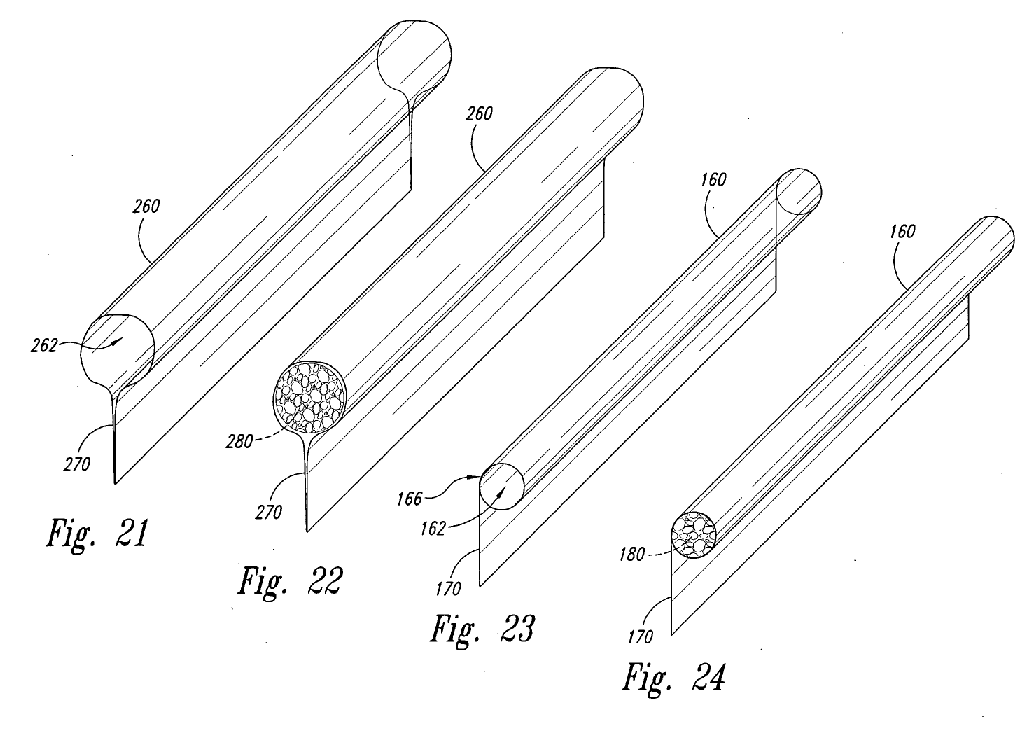

FIGS. 21-22 are isometric illustrations of portions of the shredder maintenance material delivery system shown in FIG. 17. In FIG. 21, a single sheet of material has been doubled over and sealed to form the leader 270 and the containment vessel 260. The single piece of material can be scored to form scored or perforated regions before or after the material is doubled over. The containment vessel 260 includes an interior portion 262. The maintenance material 280 is then placed in the containment vessel 260 and the end(s) of the containment vessel 260 are sealed (e.g., by pinching the material together and creating a seal or using an end piece), as shown in FIG. 22.

FIGS. 23-24 are isometric illustrations of portions of the shredder maintenance material delivery system shown in FIG. 17. In FIG. 23, a single sheet of material has been doubled over and sealed to form the leader 170 and the containment vessel 160. The material is sealed using a seal 166 that will breach under a selected set of conditions (e.g., a selected downward force). The containment vessel 160 includes an interior portion 162. The maintenance material 180 is then placed in the containment vessel 160 and the end(s) of the containment vessel 160 are sealed (e.g., by pinching the material together and creating a seal or using an end piece), as shown in FIG. 24.

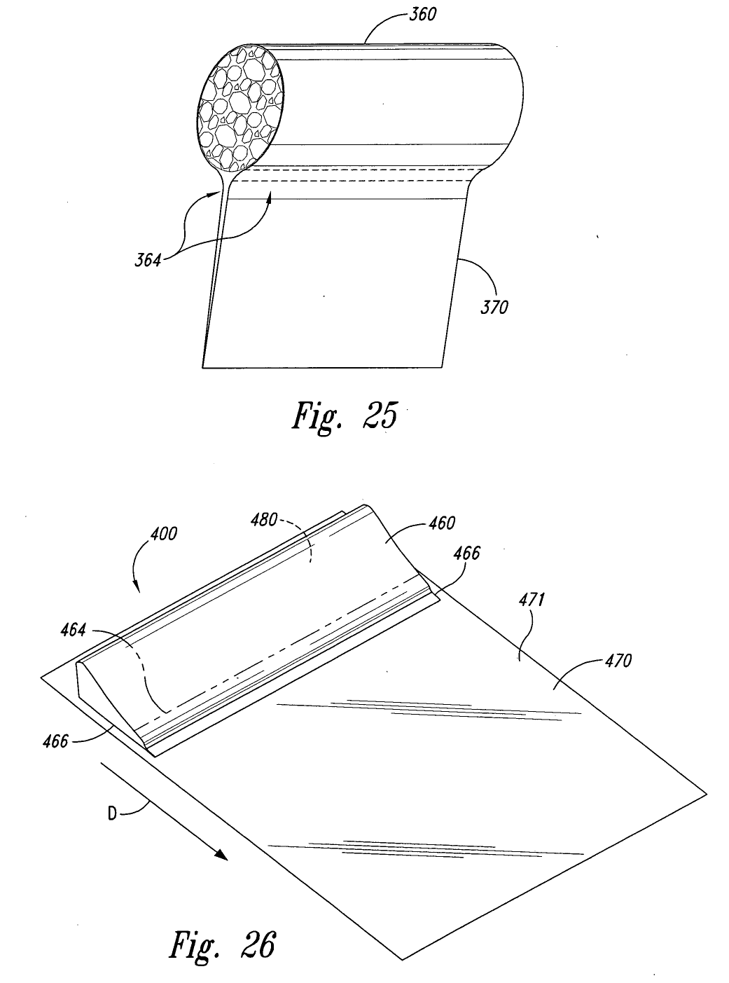

FIGS. 25-26 are isometric illustrations of a shredder maintenance material delivery system in accordance with still other embodiments of the invention. In FIG. 25, the delivery system includes a containment vessel 360 and a leader 370 similar to the containment vessel and leader shown in FIG. 18, except that the delivery system only includes one scored or perforated region 364. In FIG. 26, the delivery system 400 includes a leader 470 made of a first material. The leader is coated with a coating 471 (e.g., a reflective material, a printed pattern, or the like) to facilitate operation of an electric eye of a shredder. A containment vessel 460 made of a second material is sealed to the leader 470 via seals 466. The containment vessel 460 carries a maintenance material 480 and includes a fracture line 464 (e.g., a score line, perforation, or the like). The delivery system 400 is designed to function in a manner similar to that of the delivery system 200 shown in FIG. 17 when the delivery system 400 is fed into a shredder in the direction indicated by arrow D. In selected embodiments, the first material of the leader can be the same as the second material of the vessel. In other embodiments, the first material and the second material can be different.

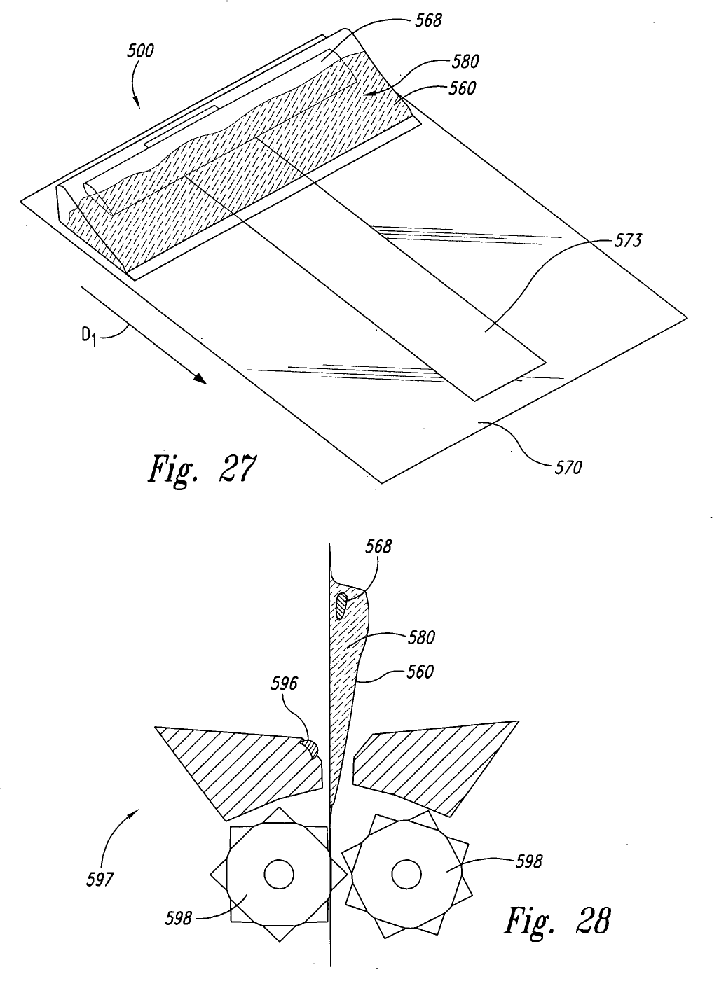

FIG. 27 is an isometric illustration of a shredder maintenance material delivery system 500 in accordance with yet other embodiments of the invention. In the illustrated embodiment, the delivery system 500 includes a leader 570 that is generally configured to break an electric eye beam (e.g., it is opaque or semi-opaque). However, the leader 570 can also include one or more dwell portions 573. In the illustrated embodiment, the dwell portions 573 are areas that are at least approximately clear and non-reflective or otherwise are areas that will not break an electric eye beam. The system 500 further includes a containment vessel 560 that carries a maintenance material 580 and a float 568. The float 568 is configured so that it will break an electric eye beam of a shredder (e.g., the float is opaque, semi-opaque, or reflective), thereby activating the shredder or causing the shredder to enter a shred mode of operation. The delivery system 500 is configured to be inserted into a shredder in the direction indicated by arrow D₁.

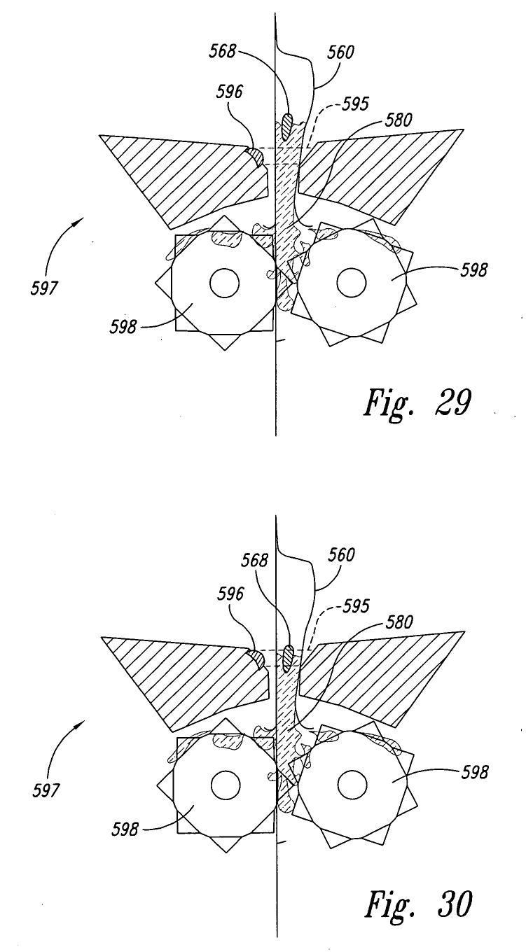

In FIG. 28, the delivery system 500 has been inserted into a shredder 597 and the float 568 is positioned (e.g., was placed at the top of the vessel when the system 500 was configured or floats to the top). The beam of an electric eye 596 has been broken by a portion of the leader 570 causing the shredder to operate in the shred mode, pulling the leader 570 and the system 500 into the shredder 597. In FIG. 29, the system 500 has been pulled sufficiently into the shredder so that the containment vessel 560 has been ruptured and maintenance material 580 is being dispensed over portions of various shredder components (e.g., the blades). The dwell portion of the leader 570 is positioned on the leader 570 so that after the system 500 has been pulled into the shredder sufficiently to cause the containment vessel to be ruptured, the dwell portion 573 will be proximate to the electric eye 596. Because the dwell portion 573 does not break the beam or interfere with a beam path 595 of the electric eye 596, the shredder blades stop 598 and the system 500 is no longer pulled into the shredder 597. In certain cases, this can allow time for a selected amount of maintenance material 580 to exit the containment vessel 560 before the containment vessel 560 is shredded. In some cases where the shredder has a delay associated with turning of the blade, the dwell portion 573 is positioned on the leader 570 to account for this delay.

As the maintenance material 580 exits the containment vessel 560, the float 568 move (e.g., via gravity) toward the shredder 597 and the electric eye beam path 595. As shown in FIG. 30, once the float 568 is proximate to the electric eye 596, the electric eye beam path is blocked and the shredder re-enters the shred mode of operation. The blades 598 begin to turn and the containment vessel is pulled through the shredder 597. In certain cases, this arrangement can allow time for a selected amount of maintenance material 580 to exit the containment vessel 560 before the containment vessel 560 is shredded.

In other embodiments, the delivery system 500 can have other arrangements. For example, in selected embodiments the system 500 can include more, fewer, and/or different dwell portions. For example, as discussed above, in other embodiments the dwell portion can include an electronic device such as a chip that causes the shredder to stop or pause for a period of time. In still other embodiments, the system 500 does not include a float and the containment vessel is lifted off the shredder after the vessel is ruptured or breached and the maintenance material has been dispensed.

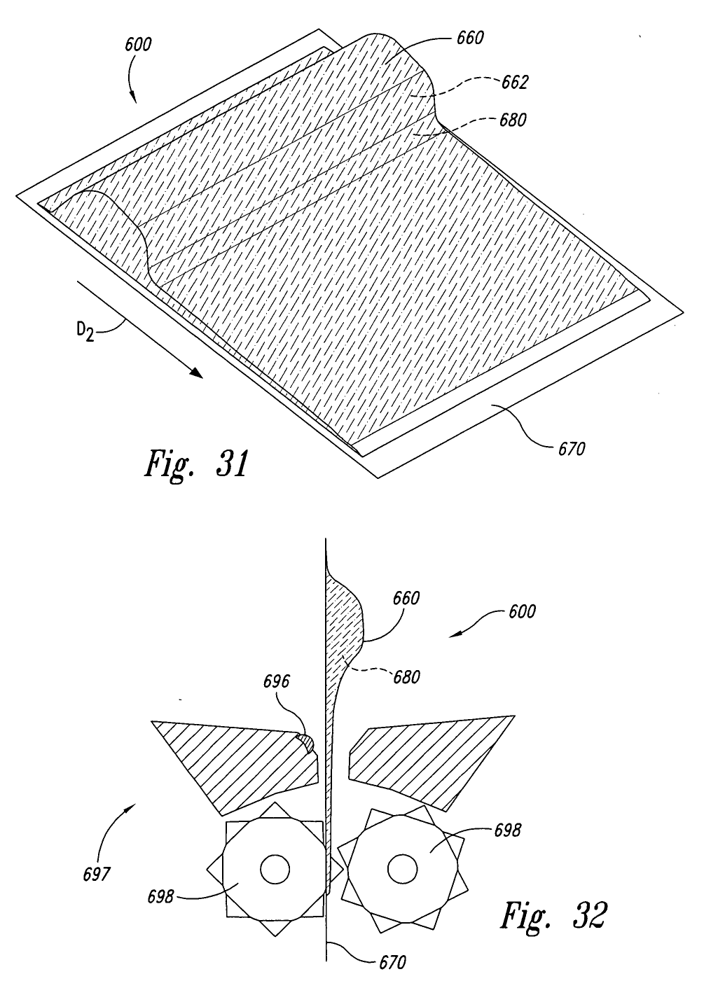

FIG. 31 is an isometric illustration of a shredder maintenance material delivery system 600 in accordance with still other embodiments of the invention. In the illustrated embodiment, the delivery system 600 includes a containment vessel 660 with an interior portion 662 carrying a maintenance material 680 coupled to a leader 670. In the illustrated embodiment, the leader material extends along an entire side (e.g., a back side) of the containment vessel 660 and is opaque, semi-opaque, and/or reflective so that it will break an electric eye beam of a shredder. In FIG. 31, the system 600 is configured to be fed into a shredder in the direction indicated by arrow D₂.

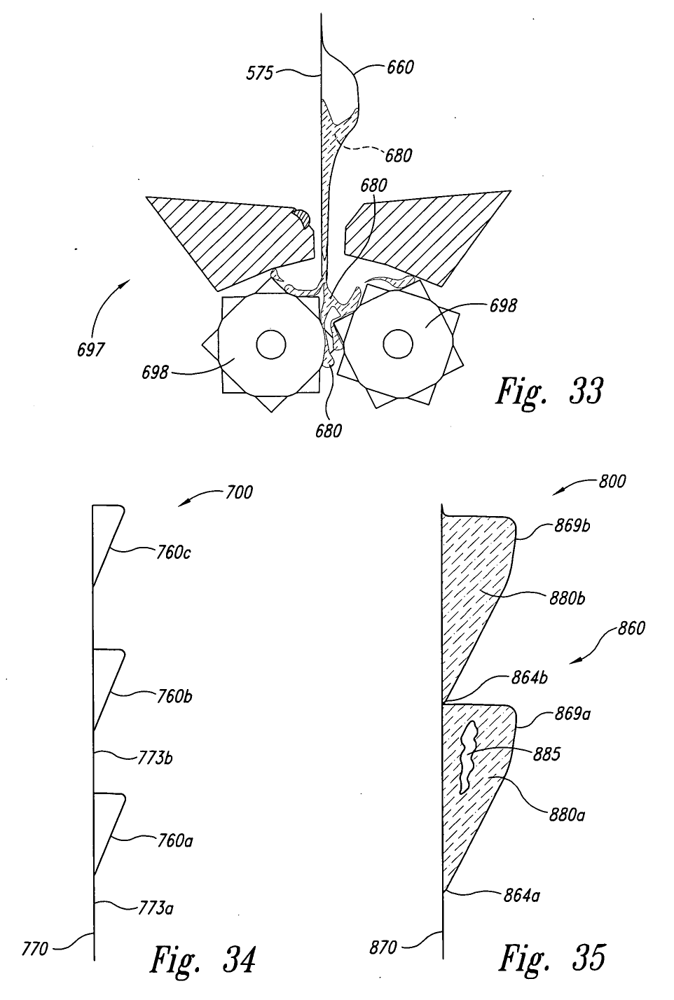

In FIG. 32, the delivery system 600 has been fed into a shredder 697. A beam from an electric eye 696 of the shredder has been broken and the blades 698 of the shredder 697 have engaged the leader 670 and are pulling the system 600 into the shredder. In FIG. 33, the containment vessel 660 has been breached. Because the containment vessel 660 extends along the leader material in the direction that the system 600 is being fed through the shredder, once the vessel 660 is breached the maintenance material 680 will dispense over the blades 698 and/or other shredder components before a substantial portion of the vessel 660 is shredded. The discharge rate of the maintenance material 680 can be controlled by the thickness (e.g., in the direction at least approximately perpendicular to the direction of feed) of the vessel 660. In FIG. 33, the side of the vessel 660 has been removed so that the maintenance material in the vessel 660 can be seen. As discussed above, because the leader material 575 (shown in FIG. 33) extends along the back of the vessel, the entire vessel will eventually be shredded.

In other embodiments, the shredder maintenance delivery system can have other arrangements. For example, FIG. 34 is a partially schematic illustration of a shredder maintenance material delivery system 700 in accordance with yet other embodiments of the invention. In FIG. 34, the delivery system 700 includes a leader 770 with three containment vessels, shown as a first containment vessel 760a, a second containment vessel 760b, and third containment vessel 760c. In the illustrated embodiment, the containment vessels can carry the same or different maintenance materials.

The first containment vessel 760a carries a float and is similar to the containment vessel discussed above with reference FIGS. 27-30. The first containment vessel is located proximate to a first dwell portion 773a. The first containment vessel and first dwell portion function in a manner similar to that discussed above with reference to FIGS. 27-30. The second containment vessel 760b carries a float and is also similar to the containment vessel discussed above with reference FIGS. 27-30. The second containment vessel 760b is located proximate to a second dwell portion 773b. The second containment vessel and second dwell portion also function in a manner similar to that discussed above with reference to FIGS. 27-30. The third containment vessel 760c is similar to the containment vessel discussed above with reference to FIG. 26 and functions in a similar manner.

Accordingly, in the illustrated embodiment, as the system 700 is fed into a shredder, the first dwell portion causes the shredder to pause while maintenance material is dispensed from the first containment vessel 760a. The first containment vessel 760a is then shredded. The second dwell portion causes the shredder to pause while maintenance material is dispensed from the second containment vessel 760b. The second containment vessel 760b is then shredded. Finally, the third containment vessel 760c is ruptured, releasing maintenance material. The third containment vessel 760c is then shredded.

In other embodiments, instead of multiple containment vessels the maintenance material delivery system can include a single containment vessel with multiple compartments. For example, FIG. 35 is a partially schematic cross-sectional side elevation of a shredder maintenance material delivery system 800 in accordance with still other embodiments of the invention. In the illustrated embodiment, the system 800 includes a leader 870 and a containment vessel 860. The containment vessel includes two compartments, shown as a first compartment 869a and a second compartment 869b. In other embodiments, the containment vessel 860 can include more or different compartments.

In FIG. 35, the first compartment carries a first maintenance material 880a and additional material 885 (e.g., a cloth). The second compartment 869bcarries a second maintenance material 880b. In selected embodiments the first and second maintenance material can be different. In other embodiments, the first and second maintenance materials can be the same. In the illustrated embodiment, the first compartment 869a includes a first fracture line 864a that is configured to operate in a manner similar to that discussed above with reference to FIG. 26. The second compartment 869b includes a second fracture line 864b that is configured to operate in a manner similar to that discussed above with reference to FIG. 26. Accordingly, as the system 800 is fed through a shredder, the first compartment 869a releases the first maintenance material 880a and the other or additional material 885, and the first compartment is shredded. The second compartment 869b then releases the second maintenance material 880b, and the second compartment is shredded.

From the foregoing, it will be appreciated that specific embodiments of the invention have been described herein for purposes of illustration, but that various modifications may be made without deviating from the invention. For example, aspects of the invention described in the context of particular embodiments may be combined or eliminated in other embodiments. Although advantages associated with certain embodiments of the invention have been described in the context of those embodiments, other embodiments may also exhibit such advantages. Additionally, not all embodiments need necessarily exhibit such advantages to fall within the scope of the invention. Accordingly, the invention is not limited except as by the appended claims.

I/We claim:

1. A shredder maintenance material delivery system substantially as described above and illustrated in figures.

2. A method of delivering maintenance material to a shredder as described above.

3. A shredder maintenance delivery system, comprising:
a leader;
a containment vessel; and
a maintenance material carried by the containment vessel, the containment vessel configured to apply the maintenance material to at least one shredder component when the delivery system is shredded.

4. The system of claim 3 wherein the maintenance material includes a lubricant.

5. The system of claim 3 wherein the maintenance material includes a cleaner.

6. The system of claim 3 wherein the maintenance material includes a liquid.

7. The system of claim 3 wherein the containment vessel is comprised of the maintenance material.

8. The system of claim 3 wherein the maintenance material includes a first maintenance material, the containment vessel is comprised of the first maintenance material, and the leader is comprised of a second maintenance material.

9. The system of claim 3 wherein the delivery system is configured so that the containment vessel applies the maintenance material to the at least one shredder component before the containment vessel is shredded.

10. The system of claim 3 wherein the containment vessel includes a first containment vessel and the maintenance material includes a first maintenance material, and wherein the system further comprises a second containment vessel configured to carry a second maintenance material.

11. The system of claim 3 wherein the leader includes at least one dwell portion.

12. The system of claim 3 wherein the containment vessel includes at least two compartments.
